(19) United States
(12) Patent Application Publication
(10) Pub. No.: US 2026/0197241 A1
(43) Pub. Date: Jul. 9, 2026

(54) TAG NORMALIZATION OF NETWORK ELEMENTS

(71) Applicant: Cisco Technology, Inc., San Jose, CA (US)

(72) Inventors: William Mark Townsley, San Francisco, CA (US); Mark Alan Bakke, Maple Grove, MN (US); Jayaraman Iyer, Sunnyvale, CA (US)

(21) Appl. No.: 19/012,054

(22) Filed: Jan. 7, 2025

(51) Int. Cl. H04L 41/122; H04L 67/10

(52) U.S. Cl. CPC H04L 41/122; H04L 67/10

(57) ABSTRACT

Techniques are described that enable tag normalization of network elements across cloud service providers in multi-cloud networks. The techniques enable customers to create and/or use tags for network elements (e.g., VPCs, VNETs, subnets, etc.), where tagging nomenclature may differ across cloud service providers, on-premises data centers, etc. The techniques enable the customers to tag their network objects across cloud service providers, and allow different tags to be normalized, or correlated, despite being associated with different nomenclature. The techniques allow network elements of multi-cloud networks to be interconnected on behalf of the user, thus improving network and customer efficiencies.

### TECHNICAL FIELD

The present invention relates generally to cloud networking and more specifically to providing tag normalization of network elements across cloud service providers.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service provider (ISP) Networks that operate WANs to provide connectivity to individual users or enterprises, software-defined networks (SDNs), wireless networks, core networks, cloud networks, and so forth.

An example network is a public cloud service provider (CSP). For instance, a customer (e.g., a tenant, such as a company or an enterprise) environment can include a single CSP or multiple CPSs, such as AWS, Azure, Oracle, etc. The customer may use multiple CPS for a variety of reasons (e.g., specific features, mergers and acquisitions, dual-vendor policies, etc.). When using the CSPs, the customer may also still operate their private clouds and branches.

As an example, a customer may have workloads running in a single CSP (e.g., such as AWS). Additionally, the customer may have hundreds or even thousands of accounts or subscriptions associated with each of these workloads. For instance, a customer (e.g., such as a company) can have various teams (e.g., application teams, marketing teams, etc.). Each team can have multiple accounts within the CSP. Where the customer runs or has hundreds of teams, there can be thousands of accounts running in the single CSP, resulting in the customer needing infrastructure and IT support to run and maintain all of the accounts. Further, when the accounts of a customer are expanded across multiple cloud systems, various additional complexities and limitations are introduced that may differ between each cloud system. As an example, each CSP has its own way of tagging network elements (e.g., cloud objects). Tags can be placed on a variety of aspects such as general resources, a VPC, an instance, a subnet, etc. However, tags are not distributed across clouds, so tracking and mapping between clouds is difficult.

### BRIEF DESCRIPTION OF THE DRAWINGS

The detailed description is set forth below with reference to the accompanying figures. The use of the same reference numbers in different figures indicates similar or identical items. The systems depicted in the accompanying figures are not to scale and components within the figures may be depicted not to scale with each other.

FIG. 1 illustrates an environment in which a system provides tag normalization in a multi-cloud mesh for multi-cloud connectivity between CSPs.

FIG. 2 illustrates an environment in which a system provides an example multi-cloud mesh that provides a simplified mechanism for managing multi-cloud connectivity between CSPs.

FIG. 3 illustrates a system-architecture diagram of an environment in which a system illustrates exemplary traffic pathways enabled by the system described in FIG. 2 herein.

FIG. 4 illustrates an example embodiment in which tag normalization enables connectivity between CSPs and via a multi-cloud mesh.

FIG. 5 illustrates a flow diagram of an example system for tag normalization in a multi-cloud mesh for multi-cloud connectivity between CSPs.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of cloud networking and more specifically to providing tag normalization of network elements across cloud service providers. For instance, the techniques described herein may relate to providing tag normalization of network elements in multi-cloud networks.

A method to perform the techniques described herein may include identifying a first tag of a first network element in a multi-cloud network (MCN), the first network element being associated with a cloud account of the MCN. The method may include identifying a second tag of a second network element in the MCN, the second network element being associated with the cloud account, and determining that the first tag corresponds to the second tag. The method may include determining, based at least in part on the first tag corresponding to the second tag, a tag mapping including an indication of the first tag and the second tag. The method may also include sending the tag mapping to a virtual point of presence (vPoP) within the MCN.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

As noted above, the use of multiple CSPs introduces various complexities for customers. Some complexities may relate to managing a customer network over multiple cloud networks. One such complexity relates to connecting different workloads and CSPs. As each cloud system has different components, connecting between cloud system(s) and the customer's private clouds and branches is difficult. For instance, a customer may want to deploy an application in two separate CSPs (e.g., such as AWS and Azure). However, how the two CSPs are structured, perform tagging, name components, etc. can be very different. This is not only highly complex but requires specialty knowledge in networking for both CSPs to enable network elements from one CSP to connect to network elements from another CSP, resulting in a need to hire staff that specialize in each CSP. Accordingly, managing the customer network can be resource intensive, complex, and costly for the customer to track and maintain.

Another complexity arises when a portion of the customer accounts are received via an acquisition or when an application team starts up from scratch. In these instances, subnet address ranges (e.g., NATs) of the accounts can overlap or have other issues that need to be addressed before the accounts can access or connect to services within the customer's network. This results in a company requiring additional specialized teams to manually correct the overlap, as well as identify and establish new connections between the customer accounts, applications, and CSPs. This is not only time-consuming and complex to sort out, but results in various accounts lacking connections to company resources and services.

Additionally, complexities can relate to inconsistencies between the different CSPs. For instance, each CSP may have inconsistencies in the capabilities between each CSP and the sites of the customer. Each CSP may have differences in the limitations of components between each CSP and networking elements of the customer. One such limitation may relate to how each CSP tags various network elements (e.g., cloud objects). For instance, each CSP has differences in what elements a customer can tag, what groups (or users) a customer can tag, what traffic a customer can tag, how to name the tags, how the tags are tracked across the CSP, etc. As an example, tags can be placed on a variety of network elements within a CSP, such as general resources, a VPC, an instance, a subnet, etc. The CSPs may each have a different way to tag instances or VPCs, but not all CSPs have a way to tag a subnet. However, tags are not distributed across clouds, so tracking and mapping between CSPs is difficult, as is enforcement of tags and policies between CSPs. Further, each CSP may be associated with different nomenclatures (e.g., different semantics, values, notations, etc.) with respect to tagging network components. As an example, at one CSP, a user may create a “finance” tag in association with a network element of the CSP (e.g., a VPC). At a different CSP, the user may create a “FinOps” tag in associated with a network element of the different CSP. A user may desire to connect to, or view information associated with, finance across the CSPs, however the different nomenclature used at various CSPs (e.g., “finance” vs. “FinOps’) makes it so the user is unable to do so.

Further, for each CSP, a customer can decide which of the customer networks to connect in different ways. As an example, the customer may use a user interface to indicate they want to connect VPC1 to VNET2. However, where there is a large amount of VPCs/VNETs, such as in a customer network described above, this is difficult to track, especially where the VPCs or VNETs are dynamic (e.g., VPCs generated with terraform) and may come into and out of existence every day, every hour, etc. Accordingly, tracking tags across CSPs is difficult and a user is unable to define their own tags in a simple way that can be utilized in cross cloud platforms.

Accordingly, there is a need to normalize tags across different CSPs utilizing different nomenclature in tagging network elements.

This disclosure describes techniques for providing tag normalization of network elements in multi-cloud networks. The techniques include identifying a first tag of a first network element in a multi-cloud network (MCN), the first network element being associated with a cloud account of the MCN. The techniques may include identifying a second tag of a second network element in the MCN, the second network element being associated with the cloud account, and determining that the first tag corresponds to the second tag. The techniques may include determining, based at least in part on the first tag corresponding to the second tag, a tag mapping including an indication of the first tag and the second tag. The techniques may also include sending the tag mapping to a virtual point of presence (vPoP) within the MCN.

In some examples, the system provides the ability to have a single network management system (NMS) and a method of operation across the CSPs in a multi-cloud network (MCN), so that the customer can run workloads in their cloud of choice for various reasons (e.g., cost, capabilities, mergers/acquisitions, etc.). In some examples, the system may operate gateways in all of the availability zones of all of the CSPs, such that the system may provide MCN management as a service. For instance, the system may correspond to the NMS that includes a dashboard (e.g., such as a Meraki dashboard) and/or is implemented as an application (e.g., such as a SaaS app) that interfaces with a user device of the customer. In some examples, the system may utilize a gateway of a service provider (e.g., such as a Cisco native gateway) instead of a gateway associated with the CSP. The system may be configured to set up encrypted tunnels between all the different gateways in order to route the traffic over the internet and between CSPs.

In some examples, the system includes virtual points of presence (vPoPs). In some examples, the vPoPs comprise cloud native head end (CNHE) vPoPs and may represent an end point that the customer talks to and/or connects to. It is understood that while vPoPs may comprise CNHE vPoPs, other types of containers may be used. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing CNHE vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts.

In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. In some examples, the vPoPs may be configured to connect the tenancies (e.g., all of Tenant A together, all of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may comprise a dashboard. In some examples, the dashboard may comprise one or more application(s) and/or API(s) that are provided by a service provider of the multi-cloud mesh (e.g., such as Cisco) to enable a customer to interface with the NMS and generate tags for various network elements. In some examples, the dashboard may enable the user to provide input to create, edit, and/or delete tag(s). In some examples, the dashboard enables the customer to tag network elements across the MCN. The dashboard may also enable the customer to indicate whether they want the NMS to connect or hook together particular traffic and/or tags. For instance, the dashboard may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the network elements that are tagged as “blue” may then be discovered by the NMS and interconnected with each other, whether vPoP is connected via AWS or Azure, and/or whether the vPoP is connected to an on-premises data center (e.g., such as via a catalyst switch or a Meraki switch).

In some examples, the system may comprise a tag component. In some examples, the tag component may be configured to generate and manage tags. For instance, the tag component may be incorporated as part of the NMS, included in the dashboard, and/or included as part of an application on a user device of a customer (e.g., outside of the multi-cloud mesh). For instance, the tag component may receive input from the dashboard. The tag component may be configured to use the input to create a tag associated with a network element. For instance, the customer may provide input that includes values for one or more fields (e.g., tag name, tag value, time stamp, object ID, nonce value, etc.) of a tag. The network elements (e.g., cloud object(s)) may include VPCs, VNETs, subnet(s), instances, network interfaces, or any other object. The tag component may generate a tag based on the values input by the customer.

In some examples, such as where the tag component is implemented on a user device of a customer (e.g., as part of an application, etc.), the tag component may, once the tag is generated, send the tag to a network element (e.g., such as a VPC of the user running in a CSP) via an API (e.g., such as an AWS API) for storage and use. The VPC at the CSP may be associated with a customer account and may store the tag in memory and utilize the tag in connection with the network element (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new network element. In some examples, the tag component may be configured to read tags received and/or generated at the user device. For instance, the tag component may receive, via the dashboard, application, and/or network element, an indication of a new tag created by the user.

In some examples, the NMS may store and track tags associated with the multi-cloud mesh and/or network elements. For instance, the NMS may store mappings between various tags, CSPs, network elements, identifier(s), etc. in a database of the multi-cloud mesh and/or in memory of the NMS. The NMS may update the mappings based on changes made to tags. As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

Additionally, or alternatively, the NMS may be configured to normalize, or correlate, different nomenclature (e.g., different tag values, notations, etc.) used in the tagging of network elements of CSPs and/or on-premises data centers. This way, mappings associated with tags may include an indication of the normalized tags (e.g., an indication of corresponding tags between different network element of CSPs and/or on-premises data centers). In some instances, the NMS may use, or work in combination with, the tag component to normalize different tags. As described above, the NMS may be configured to store and track tags associated with the multi-cloud mesh and/or network elements. Additionally, or alternatively, the NMS may be configured to determine connectivity between different network elements of CSPs and/or on-premises data centers, propagate routes, identify access permissions, etc. This information may be usable, along with other types of information, by the NMS to normalize tags. The normalized tags may then enable related network elements, components, applications, etc. of different CSPs and/or on-premises data centers to communicate with one another. For instance, the normalized tags enable the NMS to hook together traffic with a particular tag that comes from VPCs of the customer across CSPs and on-premises connections of the MCN, despite a difference in tagging nomenclature. A tag mapping may include an indication of normalized (e.g., corresponding) tags, which may be distributed to vPoP(s) that receive tagged traffic. In some instances, only the relevant vPoP(s) (e.g., a subset of the vPoP(s) that will receive traffic associated with a particular tag) may receive the tag mapping, such that not all vPoP(s) store mappings for every cloud object, thereby reducing memory and storage utilized by the multi-cloud mesh.

For example, the user may tag a network element (e.g., a subnet) within a CSP, such as AWS, with a tag such as “finance.” The user may also tag a network element within a different CSP, such as Azure, with a tag such as “FinOps.” As such, a connection may be established between the subnet within AWS and the subnet within Azure. In other words, as traffic that is associated with a “finance” tag comes through the NMS and/or MCN, the NMS may be configured to normalize the tag such that it also corresponds to the “FinOps” tag. As traffic that is associated with the “FinOps” tag comes through the NMS and/or MCN, the NMS may be configured to normalize the tag such that is also corresponds to the “finance” tag. This way, respective finance applications for the AWS subnet and Azure subnet may be communicatively coupled and/or enabled to send traffic to one another. The normalized (e.g., corresponding) tags of “finance” and “FinOps” may comprise a tag mapping, which may be used by the vPoPs in routing traffic.

As described above, the NMS may be configured to normalize tags between CSPs and on-premises network elements, and/or between an on-premises network element to another on-premises network element. For example, a vPoP may be connected to an on-premises data center. At an on-premises data center, network elements such as a catalyst switch and/or Meraki switch running in the data center may be tagged. In some examples, in an on-premises, physical data center, tagging may be more limited. Tags may include a VPNID associated with a catalyst switch, and/or a SGT (Security Group Tag) associated with a Meraki switch. In some instances, the NMS may be configured to normalize the respective tags for on-premises network elements and the respective tags of CSP network elements. The normalized tags may then enable related network elements, components, applications, etc. to communicate with one another.

By way of example, and not limitation, the NMS may normalize a VPNID=42 tag (which may indicate a finance application associated with the catalyst switch) with a “finance” tag (which may indicate a finance application associated with a subnet provided by AWS) or vice versa. As such, a connection may be established between the subnet in AWS and the on-premises catalyst switch. In other words, as traffic that is associated with a “finance” tag comes through the NMS and/or MCN, the NMS may be configured to normalize the tag such that it also corresponds to the VPNID=42. As traffic that is associated with a VPNID=42 tag comes through the NMS and/or MCN, the NMS may be configured to normalize the tag such that it also corresponds to the “finance” tag. This way, respective finance applications for the AWS subnet and the on-premises catalyst switch may be communicatively coupled and/or enabled to send traffic to one another. The normalized (e.g., corresponding) tags of VPNID=42 and “finance” may comprise a tag mapping, which may be used by the vPoPs in routing traffic.

Continuing from the example above, the NMS may also be configured to normalize the respective tags between on-premises network elements. The NMS may normalize an SGT tag (which may indicate a finance application associated with the Meraki switch) with the VPNID=42 tag, or vice versa. As such, a connection may be established between the on-premises Meraki switch and catalyst switch. In other words, as traffic that is associated with a VPNID=42 tag comes through the NMS and/or MCN, the NMS may be configured to normalize the tag such that it also corresponds to the SGT tag. As traffic that is associated with the SGT tag comes through the NMS and/or MCN, the NMS may be configured to normalize the tag such that it also corresponds to the VPNID=42 tag. This way, respective finance applications associated with the on-premises Meraki switch and catalyst switch may be communicatively coupled and/or enabled to send traffic to one another. The normalized (e.g., corresponding) tags of VPNID=42 and the SGT tag may comprise a tag mapping, which may be used by the vPoPs in routing traffic. It is understood that the techniques described in the above examples may be similarly applied to other tags, network elements, CSPs, etc. For example, the techniques may be applicable to security-related tags, confidentiality-related tags, etc.

Additionally, or alternatively, the tag mappings may include correlations between the tags of incoming tunnel(s) and/or classless inter domain routing groups (CIDR(s)) to equivalent VPNID, SGTs, etc. In some examples, the tag mappings may comprise CIDR to SGT mappings. For instance, a CIDR to SGT mapping may refer to the process of associating a specific network IP address range (defined using CIDR notation) with a SGT value, which may allow network traffic originating from that IP range (e.g., particular subnet or range of IP addresses) to be identified and treated as belonging to a particular security group of the multi-cloud mesh. A tag mapping including a correlating tunnel may refer to one or more tags assigned to traffic traversing a particular tunnel interface and may enable granular policy enforcement based on the tunnel connection, rather than just the source or destination IP addresses.

Unlike existing techniques, the NMS may establish connections between network elements based on normalized tags comprising tag mappings. For example, the NMS may receive input, such as from the user, including an indication to connect related network elements, traffic types, etc. (e.g., connecting finance-related subnets). In some instances, a user may provide input with the indication via a user interface associated with the NMS, a large language model (LLM), etc. As such, the user may only have to deploy network elements at various CSPs and tag the network elements accordingly, whereas the NMS may be configured to establish connections between the network elements on behalf of the user and based at least in part on the normalized tags.

In this way, the system may enable users to create tags of network elements using the nomenclature associated with a respective CSP, on-premises data center, and/or the like using a dashboard. By using normalized tags that indicate correlations between different tags, the system may enable users to maintain a multi-cloud network, including network elements associated with different CSPs or on-premises data centers. Additionally, while a multi-cloud network may include large amounts of networks, the system may be configured to establish connections on behalf of users. By storing the tags within the network elements (e.g., VPCs) at the cloud service provider, the system reduces the amount of memory and network bandwidth utilized by the NMS and multi-cloud mesh for tracking, managing, and normalizing tags, thereby improving scalability of the multi-cloud mesh and enabling integration in environments where network elements are created and destroyed frequently (e.g., such as terraformed environments).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

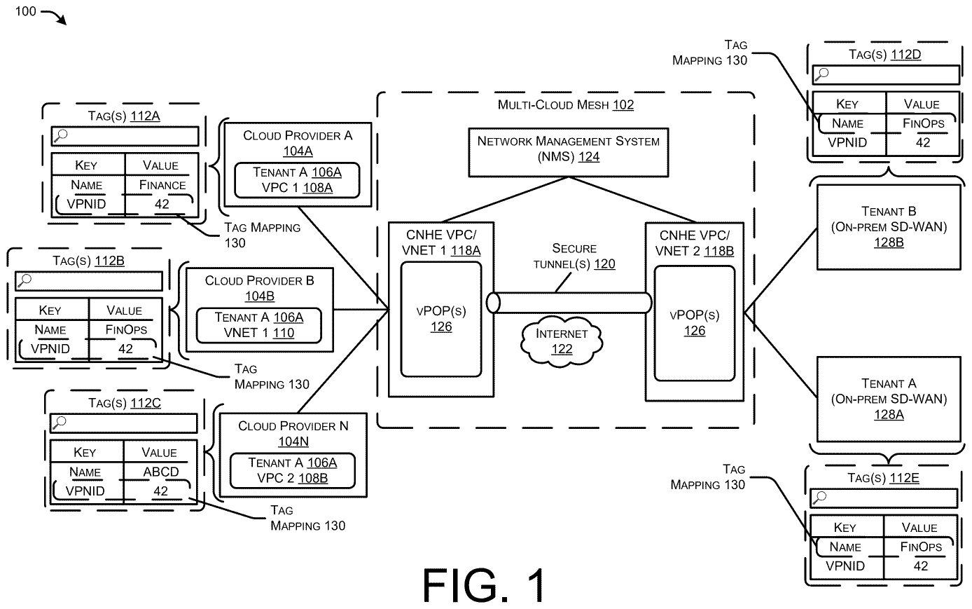

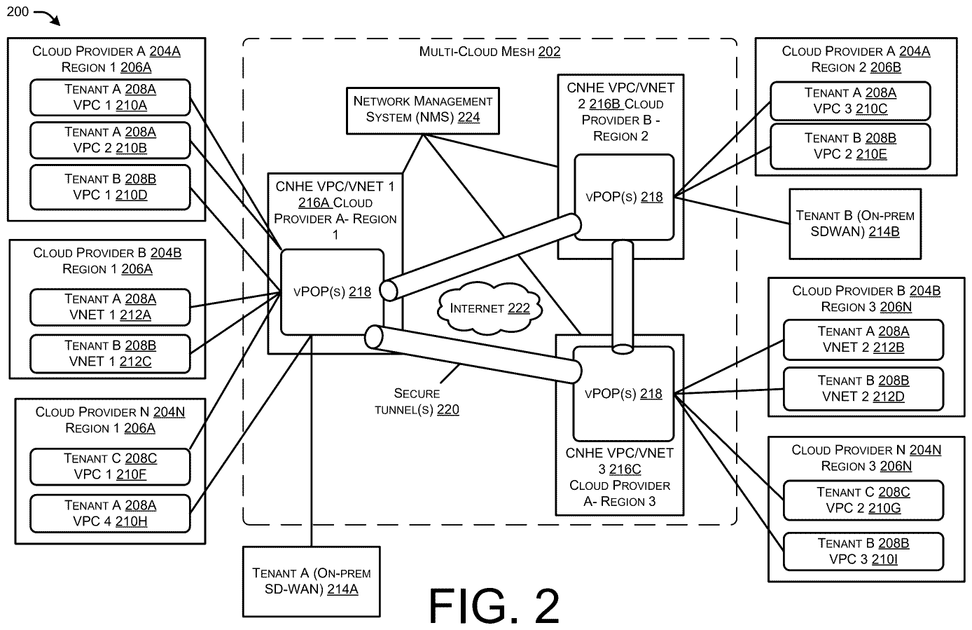

FIG. 1 illustrates an environment in which a system provides tag normalization in a multi-cloud mesh for multi-cloud connectivity between CSPs. While the system 100 shows an example multi-cloud mesh, it is understood that any of the components of the system may be implemented on any device, network, and/or any cloud-based service provider. Moreover, while the system 100 does not illustrate a network management system, it is understood that any of the components illustrated in FIGS. 2-6 may be implemented and/or incorporated in the multi-cloud mesh.

In some examples, the system 100 may include multi-cloud mesh 102. As used herein, multi-cloud mesh 102 may be referenced as the “MCN” and vice versa. As described in more detail below, the multi-cloud mesh 102 may include one or more networks implemented by any viable communication technology, such as wired and/or wireless modalities and/or technologies. The multi-cloud mesh 102 may include devices, virtual resources, or other nodes that relay packets from one network segment to another by nodes in the computer network.

The system 100 may comprise cloud provider(s) (e.g., cloud provider A 104A, cloud provider B 104B, cloud provider N 104N, “where “N” is any integer greater than one)), which may correspond to various CSPs. For instance, cloud provider A 104A may represent AWS, cloud provider B 104B may represent Azure, and cloud provider N 104N may represent GPC.

Each cloud provider 104 may be associated with a tenant 106. For example, cloud providers 104 may provide services to tenant A 106A. While not illustrated, each cloud provider 104 may be multi-tenanted. Each tenant may correspond to a different customer (e.g., such as an enterprise, organization, private entity, etc.). Additionally, or alternatively, a tenant may use multiple cloud providers 104. As illustrated, tenant A 106A may utilize services provided by cloud provider A104, cloud provider B 104B, and cloud provider N 104N. For instance, the services may include virtual private clouds (VPC 1 108A, VPC 2 108B)) or virtual networks (VNET 1 110) that each respective tenant pays the cloud service provider for. As illustrated, the services provided by each cloud provider is located outside of the multi-cloud mesh 102.

Additionally, each tenant may have one or more physical location(s). For instance, tenant B 106B may have an on-premises SD-WAN 128B. Tenant A 106A may have an on-premises SD-WAN 128A. In some examples, the on-premises SD-WANs 128 may comprise a site(s). The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs.

The multi-cloud mesh 102 may comprise network management system (NMS) 124. As described in more detail below with respect to FIG. 2, the NMS 124 may correspond to a system that has complete visibility into the fabric of a given network. In some examples, the NMS 124 may be configured to generate cloud infrastructure templates (e.g., AWS cloud formation templates) and vPoP(s) 126. As illustrated in FIG. 1, the NMS 124 may be connected to one or more CNHE VPC/VNET(s) 118 that comprise vPoP(s) 126, such that the NMS 124 can monitor, manage, and update each vPoP. It is understood that while vPoPs 126 may comprise CNHE VPC/VNET(s) 118, other types of containers may be used. The CNHE VPC/VNET(s) 118 may correspond to a VPC or a VNET that is owned and/or managed by a service provider of the NMS (e.g., such as Cisco). Accordingly, where cloud provider A 104A represents AWS, CNHE VPC/VNET 1 118A may represent instances of VPCs running in AWS. Additionally, or alternatively, CNHE VPC/VNET 2 118B may represent instances of the on-premises SD-WAN 128B of tenant B 106B.

As illustrated in FIG. 1, the vPoP(s) 126 in CNHE VPC/VNET 1 118A is configured to connect to each VPC and VNET running in cloud provider A 104A, cloud provider B 104B, and cloud provider N 104N. Additionally, the vPoP(s) 126 in CNHE VPC/VNET 1 118B may be configured to connect to tenant B on-premises SD-WAN 128B using various protocols. The vPoP(s) 126 in CNHE VPC/VNET 2 118B is configured to connect to each VPC and VNET running in each cloud provider. Additionally, the vPoP(s) 126 in CNHE VPC/VNET 2 118B may be configured to connect to tenant B 106B on-premises SD-WAN 128B using various protocols.

As illustrated, the vPoP(s) 126 are connected using secure tunnel(s) 120, which may represent encrypted data tunnels or tunnels created using any secure tunneling protocol. In some examples, the secure tunnel(s) 120 may be associated with a connection determined by a tenant, such that traffic from different tenants may be routed according to different protocols. Further, as illustrated, the vPoP(s) may be configured to communicate over the internet 122 or any other suitable network connection (e.g., core(s), 100 GB core, etc.).

In some examples, the vPoP(s) 126 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco). In some examples, the vPoP(s) 126 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

As described above, cloud providers 104 may be associated with tags 112. Tags 112 may include a tag name, tag value, object ID, nonce value, etc.). For example, VPC 1 108A of cloud provider A 104A may be tagged with tag 112A. By way of example, and not limitation, tag 112A may be a tag such as “finance” (e.g., in instances where cloud provider A 104A is AWS). Additionally, or alternatively, VNET 1 110 of cloud provider B 104B may be tagged with tag 112B. By way of example, and not limitation, tag 112B may be a tag such as “FinOps” (e.g., in instances where cloud provider B 104B is Azure). Additionally, or alternatively, VPC 2 108B of cloud provider N 104N may be tagged with tag 112C.

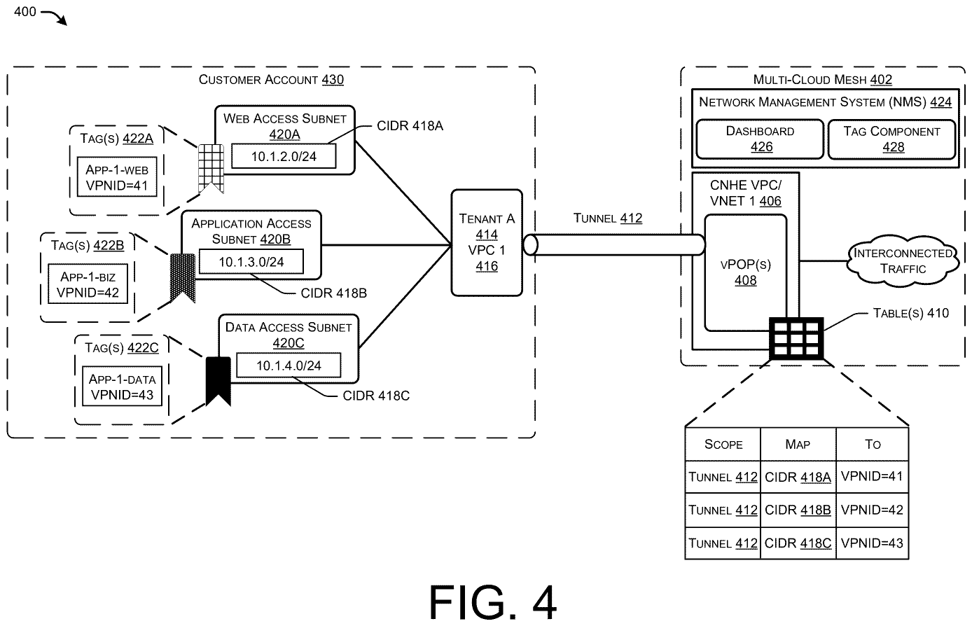

As such, the NMS 124 may be configured to connect, or hook, VPC 1 108A and VNET 1 110. In some instances, and as described below with respect to FIG. 4, the NMS 124 may use, or work in combination with, a tag component which may comprise one or more pre-trained models and/or pre-trained weighted models in order to normalize tags 112. In some examples, the artificial intelligence models are pre-trained using machine learning techniques. In some examples, the NMS 124 and/or tag component may store machine-trained data models for use during operations, such as normalizing tags 112A, 112B, and/or the like. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the tag component may update the one or more machine learning models based on feedback received from the NMS 124, outputs from the machine learning models, and/or a network administrator.

Continuing from the example above, the NMS to normalize tags 112 such that as traffic that is associated with a “finance” tag 112A comes through the NMS 124 and/or multi-cloud mesh 102, the NMS 124 may be configured to normalize the tag 112A such that it also corresponds to the “FinOps” tag 112B. As traffic that is associated with the “FinOps” tag 112B comes through the NMS 124 and/or multi-cloud mesh 102, the NMS 124 may be configured to normalize the tag 112B such that is also corresponds to the “finance” tag 112A. This way, respective finance applications for the VP 1 108A and Azure subnet and the on-premises catalyst switch may be communicatively coupled and/or enabled to send traffic to one another. The normalized (e.g., corresponding) tags 112 of “finance” and “FinOps” may comprise a tag mapping, which may be used by the vPoP(s) 126 in routing traffic.

The NMS 124 may also be configured to normalize tags 112 associated with cloud providers 104 and on-premises network elements, and/or between an on-premises network element to another on-premises network element. As illustrated, vPoP may be connected to tenant B 106B with on-premises SD-WAN 128B and/or tenant A 106A with on-premises SD-WAN 128A. For example, the on-premises SD-WAN 128B may be associated with a catalyst switch, whereas on-premises SD-WAN 128A may be associated with a Meraki switch. As such, SD-WAN 128B may be associated with a tag 112D, such as VPNID=42. The NMS 124 may normalize the VPNID=42 tag 112D (which may indicate a finance application associated with on-premises SD-WAN 128B) with “finance” tag 112A (which may indicate a finance application associated with VPC 1 108A) or vice versa. As such, a connection may be established between the VPC 1 108A in cloud provider A 104A and the on-premises SD-WAN 128B. In other words, as traffic that is associated with a “finance” tag 112A comes through the NMS 124 and/or multi-cloud mesh 102, the NMS 124 may be configured to normalize the tag 112A such that it also corresponds to the VPNID=42 tag 112D. As traffic that is associated with a VPNID=42 tag 112D comes through the NMS 124 and/or multi-cloud mesh 102, the NMS 124 may be configured to normalize the tag such that it also corresponds to the “finance” tag 112A. This way, respective finance applications for VPC 1 108A and the on-premises SD-WAN 128B may be communicatively coupled and/or enabled to send traffic to one another, such as via vPoP(s) 126 and secure tunnel(s) 120. The normalized (e.g., corresponding) tags of VPNID=42 tag 112D and “finance” tag 112A may comprise a tag mapping 130, which may be used by the vPoP(s) 126 in routing traffic.

Continuing from the example above, the NMS 124 may also be configured to normalize the respective tags 112 between on-premises network elements, such as on-premises SD-WAN 128B and 128A. The NMS 124 may normalize an SGT tag 112E (which may indicate a finance application associated with the on-premises SD-WAN 128A) with the VPNID=42 tag 112D, or vice versa. As such, a connection may be established between the on-premises SD-WAN 128B and 128A. In other words, as traffic that is associated with a VPNID=42 tag 112D comes through the NMS 124 and/or multi-cloud mesh 102, the NMS 124 may be configured to normalize the tag such that it also corresponds to the SGT tag 112E. As traffic that is associated with the SGT tag 112E comes through the NMS 124 and/or multi-cloud mesh 102, the NMS 124 may be configured to normalize the SGT tag 112E such that it also corresponds to the VPNID=42 tag 112D. This way, respective finance applications associated with the on-premises SD-WAN 128A and 128B may be communicatively coupled and/or enabled to send traffic to one another. The normalized (e.g., corresponding) tags of VPNID=42 tag 112D and the SGT tag 112E may comprise a tag mapping 130, which may be used by the vPoP(s) 126 in routing traffic.

FIG. 2 illustrates a system-architecture diagram of an environment in which a system 200 provides an example multi-cloud mesh that provides a simplified mechanism for managing multi-cloud connectivity between CSPs. While the system 200 shows an example multi-cloud mesh, it is understood that any of the components of the system may be implemented on any device, network, and/or any cloud-based service provider. Moreover, it is understood that any of the components illustrated in FIGS. 1 and 3-6 may be implemented and/or incorporated in the multi-cloud mesh. Additionally, or alternatively, system 200 may correspond to system 100 of FIG. 1. For example, one or more components of the system 200 may correspond to one or more components of the system 100 of FIG. 1 (e.g., multi-cloud mesh 202 corresponds to multi-cloud mesh 102, vPoP(s) 218 correspond to vPoP(s) 126, cloud providers A-N 204A-N correspond to cloud providers A-N 104A-N, etc.).

In some examples, the system 200 may include multi-cloud mesh 202. The multi-cloud mesh 202 may include one or more networks implemented by any viable communication technology, such as wired and/or wireless modalities and/or technologies. The multi-cloud mesh 202 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, SD-WANs, SDNs—and/or any combination, permutation, and/or aggregation thereof. The multi-cloud mesh 202 may include devices, virtual resources, or other nodes that relay packets from one network segment to another by nodes in the computer network. The multi-cloud mesh 202 may include multiple devices that utilize the network layer (and/or session layer, transport layer, etc.) in the OSI model for packet forwarding, and/or other layers. In some examples, the multi-cloud mesh 202 correspond to an SD-WAN overlay.

The system 200 may comprise cloud provider(s) (e.g., cloud provider A 204A, cloud provider B 204B, cloud provider N 204N), which may correspond to various CSPs. For instance, cloud provider A 204A may represent AWS, cloud provider B 204B may represent Azure, and cloud provider N 204N may represent GPC.

Each cloud provider may have one or more site(s) associated with a particular region (e.g., region 1 206A, region 2 206B, region 3 206N, etc.). For instance, region 1 206A may represent a western portion of a particular geographic location (e.g., country, state, city, or any other suitable geographic location), region 2 may represent a central portion of the geographic location, and region 3 206N may represent an eastern portion of the geographic location.

The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the packet-forwarding networks may not be located in explicitly defined data centers but may be located in other locations or buildings. In some examples, the site(s) comprise network device(s), which may correspond to any computing device, routers, switches, computers, or any other type of network device. Edge device(s) may comprise routers, switches, access points, stations, radios, and/or any other network device.

Each cloud provider may be multi-tenanted. For instance, cloud provider A 204A in region 1 206A may provide services to tenant A 208A and tenant B 208B. Each tenant may correspond to a different customer (e.g., such as an enterprise, organization, private entity, etc.). As illustrated, tenant A 208A may utilize services provided by cloud provider A 204A, cloud provider B 204B, and cloud provider N 204N. For instance, the services may include virtual private clouds (VPC(s) 210) or virtual networks (VNET(s) 212) that each respective tenant pays the cloud service provider for. As illustrated, the services provided by each cloud provider to each respective tenant is located outside of the multi-cloud mesh 202.

As illustrated in FIG. 2, cloud provider A 204A may run various VPCs for each tenant in each region. For instance, for tenant A 208A, cloud provider A 204A may run VPC 1 210A and VPC 2 210B in region 1 206A and VPC 3 210C in region 2 206B. For tenant B, cloud provider A 204A may also run VPC 1 210D in region 1 206A and VPC 2 210E in region 2. Similarly, cloud provider B 204B may be configured to provide VNET services to tenants. As illustrated for tenant A 208A, cloud provider B 204B may run VNET 1 212A in region 1 206A and VNET 2 212B in region 3 206N. For tenant B, cloud provider B 204B may run VNET 1 212C in region 1 206A and VNET 2 212D in region 3 206N. Cloud provider N may also be configured to provide VPC services. For instance, for tenant C 208C, cloud provider N 204N may provide VPC 1 210F in region 1 206A and VPC 2 210G in region 3. For tenant A, cloud provider N 204N may provide VPC 4 210H in region 1. For tenant B, cloud provider N may provide VPC 3 210I in region 3.

Additionally, each tenant may have one or more physical location(s). For instance, tenant A 208A may have an on-premises SD-WAN 214A. In some examples, the tenant A on-premises SD-WAN 214A may comprise a site or physical data center of tenant A. In some examples, the tenant A on-premises SD-WAN 214A may utilize features or protocols to connect to the multi-cloud mesh 202, such as Meraki and/or AutoVPN. Tenant B 208B may have an on-premises SD-WAN 214B. In some examples, the tenant B on-premises SD-WAN 214B may comprise a site or physical data center of tenant B and may be located in region 2. In some examples, the tenant B on-premises SD-WAN 214B may utilize features or protocols to connect to the multi-cloud mesh 202, such as Cisco's Catalyst IPsec and/or ISR.

The multi-cloud mesh 202 may comprise network management system (NMS) 224. The NMS 224 may correspond to a system that has complete visibility into the fabric of a given network. In some examples, the NMS 224 may comprise one or more controllers, one or more processors, memory, one or more APIs, one or more applications, one or more components, etc. In some examples, and as described in greater detail below, the NMS 224 may be configured to generate cloud infrastructure templates (e.g., AWS cloud formation templates) and vPoP(s) 218. As illustrated in FIG. 1, the NMS 224 may be connected to one or more CNHE VPC/VNET(s) 216 that comprise vPoP(s) 218, such that the NMS 224 can monitor, manage, and update each vPoP. It is understood that while vPoPs 218 may comprise CNHE VPC/VNET(s) 216, other types of containers may be used.

The CNHE VPC/VNET(s) 216 may correspond to a VPC or a VNET that is owned and/or managed by a service provider of the NMS (e.g., such as Cisco). As illustrated in FIG. 1, each CNHE VPC/VNET may be deployed within a particular cloud service provider and/or region. For instance, CNHE VPC/VNET 1 216A may run in cloud provider A region 1, CNHE VPC/VNET 2 216B may run in cloud provider B region 2, and CNHE VPC/VNET 3 216C may run in cloud provider A region 3. Accordingly, where cloud provider A represents AWS, CNHE VPC/VNET 1 216A and CNHE VPC/VNET 3 216C may represent instances of VPCs running in AWS. Where cloud provider B represents Azure, CNHE VPC/VNET 2 216B may represent instances of a VNET running in Azure. While the CNHE VPC/VNET(s) are illustrated as being run in different cloud providers, it is understood that a single CSP may be used or additional CSPs may be used.

As illustrated in FIG. 1, the vPoP(s) 218 in CNHE VPC/VNET 1 216A is configured to connect to each VPC and VNET running in cloud provider A 204A, cloud provider B 204B, and cloud provider N 204N in region 1 206A. Additionally, the vPoP(s) 218 in CNHE VPC/VNET 1 216A may be configured to connect to Tenant A on-premises SD-WAN 214A using various protocols. The vPoP(s) 218 in CNHE VPC/VNET 2 216B is configured to connect to each VPC and VNET running in each cloud provider in region 2 206B. Additionally, the vPoP(s) 218 in CNHE VPC/VNET 2 216B may be configured to connect to Tenant B on-premises SD-WAN 214B using various protocols. The vPoP(s) 218 in CNHE VPC/VNET 3 216C is configured to connect to each VPC and VNET running in each cloud provider in region 2 206B. Additionally, the vPoP(s) 218 in CNHE VPC/VNET 2 216B may be configured to connect to Tenant B on-premises SD-WAN 214B using various protocols.

As illustrated, the vPoP(s) 218 are connected using secure tunnel(s) 220, which may represent encrypted data tunnels or tunnels created using any secure tunneling protocol. In some examples, the secure tunnel(s) 220 may be associated with a connection determined by a tenant, such that traffic from different tenants may be routed according to different protocols. Further, as illustrated, the vPoP(s) may be configured to communicate over the internet 222 or any other suitable network connection (e.g., core(s), 100 GB core, etc.).

In some examples, the vPoP(s) 218 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system 200 with improved latency characteristics and enabling the system 200 to leverage specific functionalities of each CSP. Thus, by utilizing CNHE vPoPs, the system 200 may provide lightweight vPoPs that can be located anywhere (e.g., such as within a cloud) and can be set up in a new region within minutes.

Accordingly, the vPoPs deployed by the system 200 are outside of the CSP regions that are owned by the customer (e.g., and instead are deployed in VPCs/VNETs of the service provider), such that the system 200 is not deploying code, virtual machines, instances, etc. of the vPoPs to the customer network(s), thereby enabling the customer to implement the system 200 without having to allocate additional network resources (e.g., CPU, memory, etc.) of network devices, or increasing costs to the customer. Moreover, by deploying the vPoPs within the multi-cloud mesh 202, the NMS 224 is configured to handle software upgrades, security tickets, etc. on behalf of the customer, such that the customer does not need to see or handle updates or security tickets for thousands of accounts.

In some examples, the vPoP(s) 218 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the vPoP(s) 218 and/or NMS 224 may be configured to keep one or more of data traffic, routes, statistics, etc. of different tenants separate from each other. In some examples, the vPoP(s) 218 may be configured to connect the tenancies (e.g., all of Tenant A together, All of Tenant B together, etc.). Each vPoP may be configured to transmit data to each other over the internet 222, or other cores (e.g., such as a 100 GB core). Accordingly, the system may be configured to provide a per-customer topology between the vPoPs that is automated, provides flexibility in the types of tunnels, improved throughput, flexibility in the number of tunnels used (e.g., single or multiple tunnels), and/or provides balancing across the tunnels when needed (e.g., such as to get around administration limitations).

Thus, the multi-cloud mesh 202 may be configured to provide a connectivity first architecture (versus a security first architecture that runs everything through a firewall). As used herein, “connectivity first” means some of the security features of the multi-cloud mesh 202 is based on the connections selected by each tenant. For example, tenant A 208A can choose to connect VPC 1 210A and VPC 3 210C, but nothing else. In this example, the NMS 224 may distribute the routes for connecting VPC 1 210A and VPC 3 210C and may ensure that traffic sent/received by VPC 1 210A is to/from VPC 3 210C and vice versa. In some examples, the NMS 224 may distribute stateless firewalls to edge device(s) within the multi-cloud mesh 202, such that the techniques may not need to provide a central service all the time.

In this way, the system may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

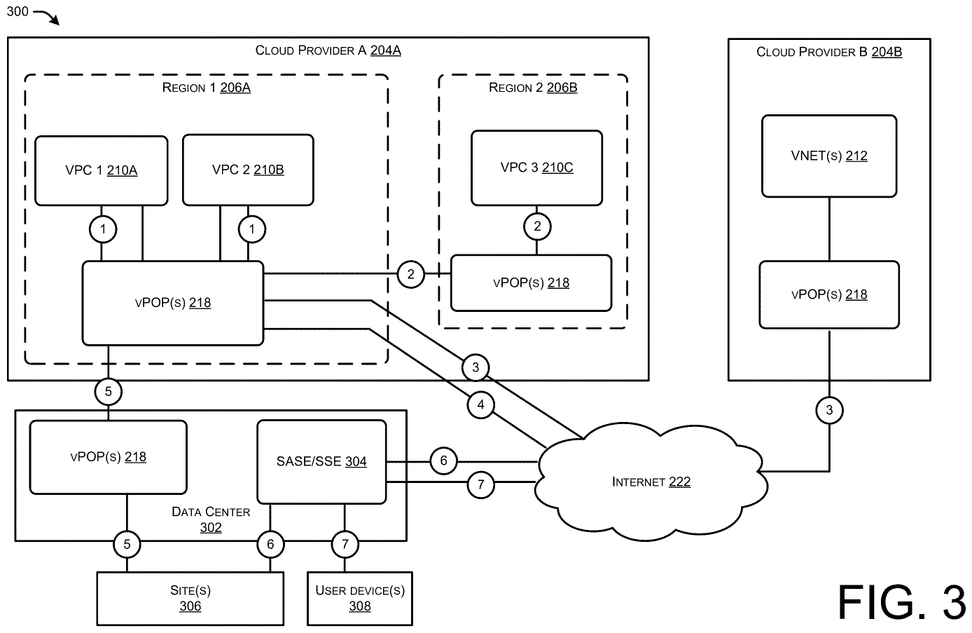

FIG. 3 illustrates a system-architecture diagram of an environment in which system 200 illustrates exemplary traffic pathways enabled by the system described in FIG. 1 herein. As illustrated, the system 200 may include cloud provider A, 204A cloud provider B 204B, region 1 206A, region 2 206B, VPC 1 210A, VPC 2 210B, VPC 3 210C, VNET(s) 212, vPoP(s) 218, and internet 222. Additionally, the system 300 may include data center 302, SASE/SSE 304, site(s) 306, and user device(s) 308.

Data center 302 may represent a physical location, such as a co-located data center, a head end, and/or any other data center associated with a service provider (e.g., such as cisco). In some examples, the data center 302 may be associated with a tenant, such as tenant A 208A. Site(s) 306 may correspond to a branch or datacenter, such as an on-premises location of tenant A 208A. User device(s) 308 may correspond to any computing device (e.g., computer, tablet, cell phone, laptop, etc.) configured to enable a network administrator or other user of tenant A 208A to connect to the multi-cloud mesh. SASE/SSE 304 may represent services (e.g., secure access services edge (SASE) and security service edge (SSE) associated with security features associated with accessing a cloud (e.g., such as SD-WAN or other connections). Further, as noted above, the vPoP(s) may be integrated and/or included as part of CNHE(s) that are configured to run multi-tenanted in a cloud as a service that is managed by a service provider (e.g., Cisco).

As illustrated, the techniques described herein enable various traffic pathways. For instance, “1” represents VPC to VPC traffic, where the vPoP(s) 218 are configured to monitor the traffic and provide simplicity, observability, security, and improved connectivity between a single region of a cloud provider. At “2”, traffic is sent between regions of a single cloud provider. In this example, the vPoP(s) 218 may be configured to add cross region encryption to the traffic, thereby providing lightweight security. “3”, illustrates that traffic may be sent cloud to cloud. In this example, the system may add cross cloud connectivity between vPoP(s). “4” illustrates that traffic may be sent cloud to internet. In this example, the vPoP(s) 218 may be configured to provide ingress and/or egress security, and may be configured to perform NAT. In some examples, pathways 1-4 are performed within the multi-cloud mesh 202, such that they do not apply to the hardware of the edge device(s).

“5” illustrates site to cloud pathway. In particular, pathway 5 illustrates the ability to utilize the vPoP(s) to enable a site 306 to automatically hook into a service provider's SD-WAN (e.g., such as Cisco SD-WAN). For instance, the site 306 may utilize Meraki AutoVPN, catalyst SD-WAN, or any other suitable protocol to enable site-to-cloud connectivity. “6” illustrates traffic sent from the site(s) 306 through the cloud. In this example, the site may utilize a SASE to connect to the multi-cloud mesh 202. “7” illustrates a device through cloud traffic pathway. In this example, the user device(s) 308 may utilize SSE 304 to connect to the multi-cloud mesh 202. Accordingly, the multi-cloud mesh 202 may utilize vPoP(s) 218 to enable various types of connections and traffic flows for tenants, thereby simplifying connectivity between different CSPs and enabling tenants to run their workloads in their cloud of choice with minimal setup or management of the connections. Thus, the vPoP(s) and the multi-cloud mesh 202 may ensure that IP addresses between VPCs/VNETs do not overlap or conflict and may provide lightweight security features. Thus, the techniques may provide a per-customer topology between vPoP(s) that is automated and provides flexibility in the type(s) and number of tunnels utilized, and may provide balancing across tunnels on behalf of the tenant.

FIG. 4 illustrates an example embodiment 400 in which tag normalization enables connectivity between CSPs and via a multi-cloud mesh. It is understood that multi-cloud mesh 402 may correspond to multi-cloud mesh 102 and/or 202, NMS 424 may correspond to NMS 124 and/or 224, CNHE VPC/VNET 406 may correspond to CNHE VPC/VNET 118A, 118B, 216A, 216B, 216C, vPoPs 408 may correspond to vPoP(s) 126 and/or 218, etc. In some instances, one or more components of the NMS 424 may run on and/or include one or more computing devices in, or associated with, the multi-cloud mesh 402 (e.g., a single device or system of devices, user device(s), etc.). Generally, the NMS 424 may include a programmable controller that manages some or all of the controller activities of the multi-cloud mesh 402 and/or MCN and manages or monitors the network state using one or more centralized control models.

In some examples, the NMS 424 may include one or more of a dashboard 426 and/or a tag component 428. In some examples, the NMS 424 may include additional or fewer components.

The dashboard 426 may comprise one or more application(s) and/or API(s) that are provided by a service provider of the multi-cloud mesh (e.g., such as Cisco) to enable a customer to interface with the network management system and generate tags for various network elements (e.g., cloud object(s)). In some examples, the dashboard may enable the user to provide input to create, edit, and/or delete tag(s). In some examples, the dashboard enables the customer to tag network elements across the multi-cloud mesh 402. The dashboard may also enable the customer to indicate whether they want the NMS 424 to connect or hook together particular traffic and/or tags. For instance, the dashboard 426 may enable the customer to hook together traffic with a particular tag that comes from VPCs of the customer across cloud service providers and on-premises connections of the MCN. As an example, the dashboard may enable the user to tag a VPC within a CSP with value(s) (e.g., VPNID, “blue,” etc.) and specify that they want all of the traffic and/or tags associated with the tag and/or values of the tag connected together. For instance, all of the vPoPs that are tagged as “blue” may then be interconnected with each other, whether vPoP is connected via AWS or Azure, and/or whether the vPoP is connected to an on-premises data center (e.g., such as via a catalyst switch or a Meraki switch). The dashboard 426 may also enable the customer to hook together traffic and/or different tags associated with different CSPs, on-premises network elements, etc.

The tag component 428 may be configured to generate, track, manage, and/or normalize tags. For instance, the tag component may be incorporated as part of the NMS, included in a dashboard, and/or included as part of an application on a user device of a customer (e.g., outside of the multi-cloud mesh). For instance, the tag component 428 may receive input from the dashboard. The tag component may be configured to use the input to create a tag associated with a network element. For instance, the customer may provide input that includes values for one or more fields (e.g., tag name, tag value, object ID, nonce value, etc.) of a tag, such as tags 422A. The network elements may include VPCs, VNETs, subnet(s), instances, network interfaces, or any other object.

In some examples, such as where the tag component is implemented on a user device of a customer (e.g., as part of an application, etc.), the tag component 428 may, once the tag is generated, send the tag to a network element (e.g., such as a VPC of the user running in a CSP) via an API (e.g., such as an AWS API) for storage and use. The VPC at the CSP may be associated with a customer account and may store the tag in memory and utilize the tag in connection with the network element (e.g., such as when forming a secure tunnel, tagging traffic, etc.). In this example, the tag may be deleted either through the tag component 428 on the user device or when the VPC is removed or deleted (e.g., such as in a terraformed environment). Accordingly, when a new VPC is created, the system may identify that the VPC is a new network element.

In some examples, the NMS 424 may store and track tags 422 associated with the multi-cloud mesh 402 and/or network elements. For instance, the NMS 424 may store mappings between various tags, CSPs, network elements, identifier(s), etc. in a database of the multi-cloud mesh and/or in memory of the NMS 424. The NMS 424 may update mappings based on changes made to tags 422A, as well as based on normalizations associated with the tags 422A. For example, as described above, the NMS 424 may be configured to normalize, or correlate, different nomenclature (e.g., different tag values, notations, etc.) used in the tagging of network elements of CSPs and/or on-premises data centers. In some examples, the NMS 424 may use, or work in combination with, the tag component 428 in order to normalize different tags. In normalizing the tags 422, the NMS 424 may map different tags to one another. Customer account 430 may be associated with different access subnets 420 associated with tenant A 414 and VPC 1 416. For example, web access subnet 420A of customer account 430 may be tagged with tag(s) 422A such as “App-1-Web.” The NMS 424 may be configured to map the “App-1-Web” to a tag of VPNID=41. Web access subnet 420B of customer account 430 may be tagged with tag(s) 422B such as “App-1-Biz.” The NMS 424 may be configured to map the “App-1-Biz” to a tag of VPNID=42. Web access subnet 420C of customer account 430 may be tagged with tag(s) 422C such as “App-1-Data.” The NMS 424 may be configured to map the “App-1-Data” to a tag of VPNID=43. These tag mappings may then be distributed to the relevant vPoPs, such as vPoP(s) 408 of CNHE VPC/VNET 406. Additionally, or alternatively, tag mappings may include mappings between tags of incoming tunnel(s) and/or classless inter domain routing groups (CIDR(s)) to equivalent VPNIDs, SGTs, etc. For instance, a CIDR to VPNID mapping may refer to the process of associating a specific network IP address range (defined using CIDR notation) with a VPNID value, which may allow network traffic originating from that IP range (e.g., particular subnet or range of IP addresses) to be identified within the multi-cloud mesh 402. Tag normalization may also include correlating tags assigned to traffic traversing a particular tunnel interface, such as tunnel 412, and may enable granular policy enforcement based on the tunnel connection, rather than just the source or destination IP addresses.

For example, a CIDR 418A may be mapped to VPNID=41, where traffic that may come over the tunnel 412 and matching CIDR 418A may be mapped to VPNID=41. In other words, traffic coming over the tunnel 412 and matching the CIDR 418A may “take on” the VPNID=41 in the multi-cloud mesh 402. CIDR 418B may be mapped to VPNID=42, where traffic that may come over the tunnel 412 and matching CIDR 418B may be mapped to VPNID=42. In other words, traffic coming over the tunnel 412 and matching the CIDR 418B may “take on” the VPNID=42 in the multi-cloud mesh 402. CIDR 418C may be mapped to VPNID=43, where traffic that may come over the tunnel 412 and matching CIDR 418C may be mapped to VPNID=43. In other words, traffic coming over the tunnel 412 and matching the CIDR 418C may “take on” the VPNID=43 in the multi-cloud mesh 402. These mappings may be distributed to relevant vPoPs, such as vPoP(s) 408, as a table 410. The table 410 may be stored in memory of the vPoP(s) 408 and/or network elements that the vPoP(s) 408 are running in (e.g., CNHE VPC/VNET 1 406).

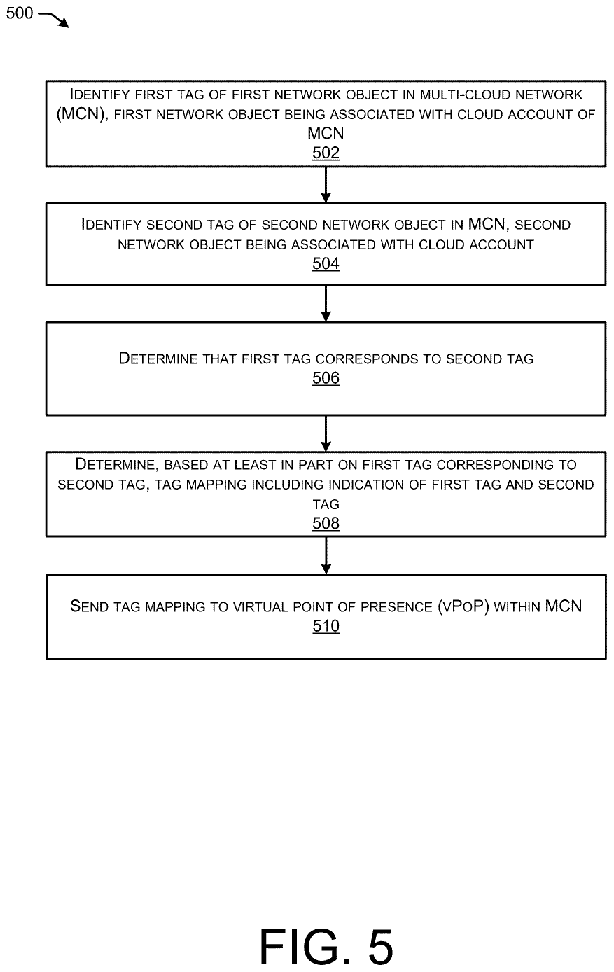

FIG. 5 illustrates a flow diagram of an example system 500 for providing tag normalization of network elements across cloud service providers, according to the systems and techniques described in FIGS. 1-4. In some instances, one or more of the steps of system 500 may be performed by one or more devices (e.g., the NMS 124, user device(s) 308, etc.) that include one or more processors and one or more non-transitory computer-readable media storing computer-executable instructions that, when executed by the one or more processors, cause the one or more processors to perform operations of system 500.

At 502, the system may include identifying a first tag of a first network element in the MCN, the first network element being associated with a cloud account of the MCN. For example, the system may comprise a tag component. In some examples, the tag component may be configured to generate and manage tags. For instance, the tag component may be incorporated as part of the NMS, included in the dashboard, and/or included as part of an application on a user device of a customer (e.g., outside of the multi-cloud mesh). For instance, the tag component may receive input from the dashboard. The tag component may be configured to use the input to create a tag associated with a network element. For instance, the customer may provide input that includes values for one or more fields (e.g., tag name, tag value, time stamp, object ID, nonce value, etc.) of a tag. The network elements (e.g., cloud object(s)) may include VPCs, VNETs, subnet(s), instances, network interfaces, or any other object. The tag component may generate a tag based on the values input by the customer.

In some examples, such as where the tag component is implemented on a user device of a customer (e.g., as part of an application, etc.), the tag component may, once the tag is generated, send the tag to a network element (e.g., such as a VPC of the user running in a CSP) via an API (e.g., such as an AWS API) for storage and use. The VPC at the CSP may be associated with a customer account and may store the tag in memory and utilize the tag in connection with the network element (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new network element. In some examples, the tag component may be configured to read tags received and/or generated at the user device. For instance, the tag component may receive, via the dashboard, application, and/or network element, an indication of a new tag created by the user.

At 504, the system may include identifying a second tag of a second network element in the MCN, the second network element being associated with the cloud account. For example, the system may comprise a tag component. In some examples, the tag component may be configured to generate and manage tags. For instance, the tag component may be incorporated as part of the NMS, included in the dashboard, and/or included as part of an application on a user device of a customer (e.g., outside of the multi-cloud mesh). For instance, the tag component may receive input from the dashboard. The tag component may be configured to use the input to create a tag associated with a network element. For instance, the customer may provide input that includes values for one or more fields (e.g., tag name, tag value, time stamp, object ID, nonce value, etc.) of a tag. The network elements (e.g., cloud object(s)) may include VPCs, VNETs, subnet(s), instances, network interfaces, or any other object. The tag component may generate a tag based on the values input by the customer.

In some examples, such as where the tag component is implemented on a user device of a customer (e.g., as part of an application, etc.), the tag component may, once the tag is generated, send the tag to a network element (e.g., such as a VPC of the user running in a CSP) via an API (e.g., such as an AWS API) for storage and use. The VPC at the CSP may be associated with a customer account and may store the tag in memory and utilize the tag in connection with the network element (e.g., such as when forming a secure tunnel, tagging traffic, etc.). In this example, the tag may be deleted either through the tag component on the user device or when the VPC is removed or deleted (e.g., such as in a terraformed environment). Accordingly, when a new VPC is created, the system may identify that the VPC is a new network element. In some examples, the tag component may be configured to read tags received and/or generated at the user device. For instance, the tag component may receive, via the dashboard, application, and/or network element, an indication of a new tag created by the user.

At 506, the system may include determining that the first tag corresponds to the second tag. For example, the NMS may store and track tags associated with the multi-cloud mesh and/or network elements. For instance, the NMS may store mappings between various tags, CSPs, network elements, identifier(s), etc. in a database of the multi-cloud mesh and/or in memory of the NMS. The NMS may update the mappings based on changes made to tags. As an example, tags may be configured to translate into actions (e.g., connectivity, priority of traffic, performance of traffic, access permissions, etc.) within the multi-cloud mesh. The NMS may utilize mappings of tags to determine if a policy enables a user to connect to a particular vPoP, account, etc. across CSPs of the MCN.

At 508, the system may include determining, based at least in part on the first tag corresponding to the second tag, a tag mapping including an indication of the first tag and the second tag. For example, the NMS may be configured to normalize, or correlate, different nomenclature (e.g., different tag values, notations, etc.) used in the tagging of network elements of CSPs and/or on-premises data centers. This way, mappings associated with tags may include an indication of the normalized tags (e.g., an indication of corresponding tags between different network element of CSPs and/or on-premises data centers). In some instances, the NMS may use, or work in combination with, the tag component to normalize different tags. As described above, the NMS may be configured to store and track tags associated with the multi-cloud mesh and/or network elements. Additionally, or alternatively, the NMS may be configured to determine connectivity between different network elements of CSPs and/or on-premises data centers, propagate routes, identify access permissions, etc. This information may be usable, along with other types of information, by the NMS to normalize tags. The normalized tags may then enable related network elements, components, applications, etc. of different CSPs and/or on-premises data centers to communicate with one another. For instance, the normalized tags enable the NMS to hook together traffic with a particular tag that comes from VPCs of the customer across CSPs and on-premises connections of the MCN, despite a difference in tagging nomenclature. A tag mapping may include an indication of normalized (e.g., corresponding) tags, which may be distributed to vPoP(s) that receive tagged traffic. In some instances, only the relevant vPoP(s) (e.g., a subset of the vPoP(s) that will receive traffic associated with a particular tag) may receive the tag mapping, such that not all vPoP(s) store mappings for every cloud object, thereby reducing memory and storage utilized by the multi-cloud mesh.

For example, the user may tag a network element (e.g., a subnet) within a CSP, such as AWS, with a tag such as “finance.” The user may also tag a network element within a different CSP, such as Azure, with a tag such as “FinOps.” As such, a connection may be established between the subnet within AWS and the subnet within Azure. In other words, as traffic that is associated with a “finance” tag comes through the NMS and/or MCN, the NMS may be configured to normalize the tag such that it also corresponds to the “FinOps” tag. As traffic that is associated with the “FinOps” tag comes through the NMS and/or MCN, the NMS may be configured to normalize the tag such that is also corresponds to the “finance” tag. This way, respective finance applications for the AWS subnet and Azure subnet may be communicatively coupled and/or enabled to send traffic to one another. The normalized (e.g., corresponding) tags of “finance” and “FinOps” may comprise a tag mapping, which may be used by the vPoPs in routing traffic.

As described above, the NMS may be configured to normalize tags between CSPs and on-premises network elements, and/or between an on-premises network element to another on-premises network element. For example, a vPoP may be connected to an on-premises data center. At an on-premises data center, network elements such as a catalyst switch and/or Meraki switch running in the data center may be tagged. In some examples, in an on-premises, physical data center, tagging may be more limited. Tags may include a VPNID associated with a catalyst switch, and/or a SGT (Security Group Tag) associated with a Meraki switch. In some instances, the NMS may be configured to normalize the respective tags for on-premises network elements and the respective tags of CSP network elements. The normalized tags may then enable related network elements, components, applications, etc. to communicate with one another.

By way of example, and not limitation, the NMS may normalize a VPNID=42 tag (which may indicate a finance application associated with the catalyst switch) with a “finance” tag (which may indicate a finance application associated with a subnet provided by AWS) or vice versa. As such, a connection may be established between the subnet in AWS and the on-premises catalyst switch. In other words, as traffic that is associated with a “finance” tag comes through the NMS and/or MCN, the NMS may be configured to normalize the tag such that it also corresponds to the VPNID=42. As traffic that is associated with a VPNID=42 tag comes through the NMS and/or MCN, the NMS may be configured to normalize the tag such that it also corresponds to the “finance” tag. This way, respective finance applications for the AWS subnet and the on-premises catalyst switch may be communicatively coupled and/or enabled to send traffic to one another. The normalized (e.g., corresponding) tags of VPNID=42 and “finance” may comprise a tag mapping, which may be used by the vPoPs in routing traffic.

Continuing from the example above, the NMS may also be configured to normalize the respective tags between on-premises network elements. The NMS may normalize an SGT tag (which may indicate a finance application associated with the Meraki switch) with the VPNID=42 tag, or vice versa. As such, a connection may be established between the on-premises Meraki switch and catalyst switch. In other words, as traffic that is associated with a VPNID=42 tag comes through the NMS and/or MCN, the NMS may be configured to normalize the tag such that it also corresponds to the SGT tag. As traffic that is associated with the SGT tag comes through the NMS and/or MCN, the NMS may be configured to normalize the tag such that it also corresponds to the VPNID=42 tag. This way, respective finance applications associated with the on-premises Meraki switch and catalyst switch may be communicatively coupled and/or enabled to send traffic to one another. The normalized (e.g., corresponding) tags of VPNID=42 and the SGT tag may comprise a tag mapping, which may be used by the vPoPs in routing traffic. It is understood that the techniques described in the above examples may be similarly applied to other tags, network elements, CSPs, etc. For example, the techniques may be applicable to security-related tags, confidentiality-related tags, etc.

Additionally, or alternatively, the tag mappings may include correlations between the tags of incoming tunnel(s) and/or classless inter domain routing groups (CIDR(s)) to equivalent VPNID, SGTs, etc. In some examples, the tag mappings may comprise CIDR to SGT mappings. For instance, a CIDR to SGT mapping may refer to the process of associating a specific network IP address range (defined using CIDR notation) with a SGT value, which may allow network traffic originating from that IP range (e.g., particular subnet or range of IP addresses) to be identified and treated as belonging to a particular security group of the multi-cloud mesh. A tag mapping including a correlating tunnel may refer to one or more tags assigned to traffic traversing a particular tunnel interface and may enable granular policy enforcement based on the tunnel connection, rather than just the source or destination IP addresses.

At 510, the system may include sending the tag mapping to a virtual point of presence (vPoP) within the MCN. For example, and as described above, the NMS may also be configured to normalize the respective tags between on-premises network elements. The NMS may normalize an SGT tag (which may indicate a finance application associated with the Meraki switch) with the VPNID=42 tag, or vice versa. As such, a connection may be established between the on-premises Meraki switch and catalyst switch. In other words, as traffic that is associated with a VPNID=42 tag comes through the NMS and/or MCN, the NMS may be configured to normalize the tag such that it also corresponds to the SGT tag. As traffic that is associated with the SGT tag comes through the NMS and/or MCN, the NMS may be configured to normalize the tag such that it also corresponds to the VPNID=42 tag. This way, respective finance applications associated with the on-premises Meraki switch and catalyst switch may be communicatively coupled and/or enabled to send traffic to one another. The normalized (e.g., corresponding) tags of VPNID=42 and the SGT tag may comprise a tag mapping, which may be used by the vPoPs in routing traffic. It is understood that the techniques described in the above examples may be similarly applied to other tags, network elements, CSPs, etc. For example, the techniques may be applicable to security-related tags, confidentiality-related tags, etc.

Additionally, or alternatively, the system 500 may include, wherein the tag mapping is a first tag mapping, first network element is an on-premises network element, and the second network element is a cloud-based network element, identifying an SGT tag of the on-premises network element in the MCN and associated with the cloud account, and identifying a cloud tag of the cloud-based network element in the MCN and associated with the cloud account. The system 500 may further include determining the SGT tag corresponds to the cloud tag, determining, based at least in part on the SGT tag corresponding to the cloud tag, a second tag mapping including an indication of the SGT tag and the cloud tag, and sending the second tag mapping to the vPoP within the MCN.

Additionally, or alternatively, the system 500 may include wherein the first tag and second tag comprise at least one of a tag name, a tag value, a time stamp, an object identifier, an entity identifier, or a nonce value.

Additionally, or alternatively, the system 500 may include wherein the first network element and second network element comprise one of a virtual private cloud, a virtual network, a network interface, an instance, or a subnet associated with the cloud account.

Additionally, or alternatively, the system 500 may include, wherein the tag mapping includes at least a mapping between the first tag and one of a tunnel or a classless inter domain routing (CIDR) group, receiving, by the vPoP and from the first network element, a data packet associated with the first tag and the at least one of the tunnel or the CIDR group, based at least in part on the tag mapping, causing the data packet to be associated with the second tag, and based at least in part on the data packet being associated with the second tag, sending the data packet to the second network element.

Additionally, or alternatively, the system 500 may include, wherein the tag mapping includes at least a mapping between the first tag and one of a tunnel or a classless inter domain routing (CIDR) group, receiving, by the vPoP and from the first network element, a data packet associated with a third tag and the at least one of the tunnel or the CIDR group, and based at least in part on the tag mapping, refraining from causing the data packet to be associated with the second tag.

Additionally, or alternatively, the system 500 may include identifying a third network element in the MCN, the third network element being associated with the cloud account, identifying a third tag of the third network element, determining that the third tag corresponds to the first tag and the second tag, and updating the tag mapping to include an indication of the third tag.

Additionally, or alternatively, the system 500 may include wherein the first tag is generated by a first application associated with a first cloud service provider of the cloud account, and wherein generating the first tag further comprises receiving input via the first application comprising values associated with the first tag.

In this way, the system may enable users to create tags of network elements using the nomenclature associated with a respective CSP, on-premises data center, and/or the like using a dashboard. By using normalized tags that indicate correlations between different tags, the system may enable users to maintain a multi-cloud network, including network elements associated with different CSPs or on-premises data centers. Additionally, while a multi-cloud network may include large amounts of networks, the system may be configured to establish connections on behalf of users. By storing the tags within the network elements (e.g., VPCs) at the cloud service provider, the system reduces the amount of memory and network bandwidth utilized by the NMS and multi-cloud mesh for tracking, managing, and normalizing tags, thereby improving scalability of the multi-cloud mesh and enabling integration in environments where network elements are created and destroyed frequently (e.g., such as terraformed environments).

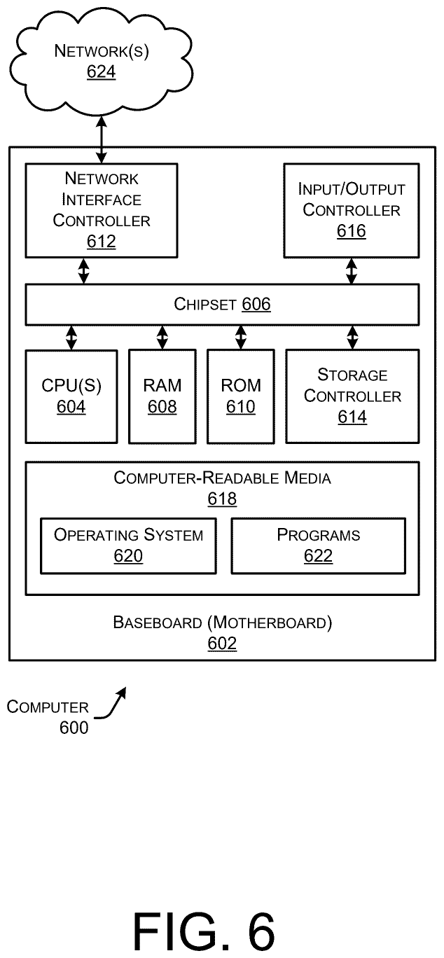

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a NMS 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs 604”) operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 624. The network(s) 624 may correspond to internet 122, the multi-cloud mesh 102, etc. The chipset 606 can include functionality for providing network connectivity through a NIC 612, such as a gigabit Ethernet adapter. The NIC 612 is capable of connecting the computer 600 to other computing devices over the network(s) 624. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the NMS 124, and/or any components included therein, may be supported by one or more devices similar to computer 600. Stated otherwise, some or all of the operations performed by the NMS 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-6. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a NMS 124, and/or any other device. The computer 600 may include one or more hardware processors (processor(s), such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the NMS 124, and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including identifying a first tag of a first network element in a multi-cloud network (MCN), the first network element being associated with a cloud account of the MCN; identifying a second tag of a second network element in the MCN, the second network element being associated with the cloud account; determining that the first tag corresponds to the second tag; determining, based at least in part on the first tag corresponding to the second tag, a tag mapping including an indication of the first tag and the second tag; and sending the tag mapping to a virtual point of presence (vPoP) within the MCN. In this way, the computer 600 may enable the normalization of tags across different CSPs using different nomenclature in tagging network elements.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of providing tag normalization of network elements in a multi-cloud network (MCN), comprising:
identifying a first tag of a first network element in the MCN, the first network element being associated with a cloud account of the MCN;
identifying a second tag of a second network element in the MCN, the second network element being associated with the cloud account;
determining that the first tag corresponds to the second tag;
determining, based at least in part on the first tag corresponding to the second tag, a tag mapping including an indication of the first tag and the second tag; and
sending the tag mapping to a virtual point of presence (vPoP) within the MCN.

2. The method of claim 1, wherein the tag mapping is a first tag mapping, first network element is an on-premises network element, and the second network element is a cloud-based network element, the method further comprising:
identifying an SGT tag of the on-premises network element in the MCN and associated with the cloud account;
identifying a cloud tag of the cloud-based network element in the MCN and associated with the cloud account;
determining the SGT tag corresponds to the cloud tag;
determining, based at least in part on the SGT tag corresponding to the cloud tag, a second tag mapping including an indication of the SGT tag and the cloud tag; and
sending the second tag mapping to the vPoP within the MCN.

3. The method of claim 1, wherein the first tag and second tag comprise at least one of a tag name, a tag value, a time stamp, an object identifier, an entity identifier, or a nonce value.

4. The method of claim 1, wherein the first network element and second network element comprise one of a virtual private cloud, a virtual network, a network interface, an instance, or a subnet associated with the cloud account.

5. The method of claim 1, wherein the tag mapping includes at least a mapping between the first tag and one of a tunnel or a classless inter domain routing (CIDR) group, the method further comprising:
receiving, by the vPoP and from the first network element, a data packet associated with the first tag and the at least one of the tunnel or the CIDR group;
based at least in part on the tag mapping, causing the data packet to be associated with the second tag; and
based at least in part on the data packet being associated with the second tag, sending the data packet to the second network element.

6. The method of claim 1, wherein the tag mapping includes at least a mapping between the first tag and one of a tunnel or a classless inter domain routing (CIDR) group, the method further comprising:
receiving, by the vPoP and from the first network element, a data packet associated with a third tag and the at least one of the tunnel or the CIDR group; and
based at least in part on the tag mapping, refraining from causing the data packet to be associated with the second tag.

7. The method of claim 1, further comprising:
identifying a third network element in the MCN, the third network element being associated with the cloud account;
identifying a third tag of the third network element;
determining that the third tag corresponds to the first tag and the second tag; and
updating the tag mapping to include an indication of the third tag.

8. The method of claim 1, wherein the first tag is generated by a first application associated with a first cloud service provider of the cloud account, and wherein generating the first tag further comprises receiving input via the first application comprising values associated with the first tag.

9. A system comprising:
one or more processors; and
one or more computer-readable media storing instructions that, when executed by the one or more processors, cause the one or more processors to perform operations comprising:
identifying a first tag of a first network element in a multi-cloud network (MCN), the first network element being associated with a cloud account of the MCN;
identifying a second tag of a second network element in the MCN, the second network element being associated with the cloud account;
determining that the first tag corresponds to the second tag;
determining, based at least in part on the first tag corresponding to the second tag, a tag mapping including an indication of the first tag and the second tag; and
sending the tag mapping to a virtual point of presence (vPoP) within the MCN.

10. The system of claim 9, wherein the tag mapping is a first tag mapping, first network element is an on-premises network element, and the second network element is a cloud-based network element, the operations further comprising:
identifying an SGT tag of the on-premises network element in the MCN and associated with the cloud account;
identifying a cloud tag of the cloud-based network element in the MCN and associated with the cloud account;
determining the SGT tag corresponds to the cloud tag;
determining, based at least in part on the SGT tag corresponding to the cloud tag, a second tag mapping including an indication of the SGT tag and the cloud tag; and
sending the second tag mapping to the vPoP within the MCN.

11. The system of claim 9, wherein the first tag and second tag comprise at least one of a tag name, a tag value, a time stamp, an object identifier, an entity identifier, or a nonce value.

12. The system of claim 9, wherein the first network element and second network element comprise one of a virtual private cloud, a virtual network, a network interface, an instance, or a subnet associated with the cloud account.

13. The system of claim 9, wherein the tag mapping includes at least a mapping between the first tag and one of a tunnel or a classless inter domain routing (CIDR) group, the operations further comprising:
receiving, by the vPoP and from the first network element, a data packet associated with the first tag and the at least one of the tunnel or the CIDR group;
based at least in part on the tag mapping, causing the data packet to be associated with the second tag; and
based at least in part on the data packet being associated with the second tag, sending the data packet to the second network element.

14. The system of claim 9, wherein the tag mapping includes at least a mapping between the first tag and one of a tunnel or a classless inter domain routing (CIDR) group, the operations further comprising:
receiving, by the vPoP and from the first network element, a data packet associated with a third tag and the at least one of the tunnel or the CIDR group; and
based at least in part on the tag mapping, refraining from causing the data packet to be associated with the second tag.

15. The system of claim 9, the operations further comprising:
identifying a third network element in the MCN, the third network element being associated with the cloud account;
identifying a third tag of the third network element;
determining that the third tag corresponds to the first tag and the second tag; and
updating the tag mapping to include an indication of the third tag.

16. The system of claim 9, wherein the first tag is generated by a first application associated with a first cloud service provider of the cloud account, and wherein generating the first tag further comprises receiving input via the first application comprising values associated with the first tag.

17. One or more non-transitory computer-readable media maintaining instructions that, when executed by one or more processors, program the one or more processors to perform operations comprising:
identifying a first tag of a first network element in a multi-cloud network (MCN), the first network element being associated with a cloud account of the MCN;
identifying a second tag of a second network element in the MCN, the second network element being associated with the cloud account;
determining that the first tag corresponds to the second tag;
determining, based at least in part on the first tag corresponding to the second tag, a tag mapping including an indication of the first tag and the second tag; and
sending the tag mapping to a virtual point of presence (vPoP) within the MCN.

18. The one or more non-transitory computer-readable media of claim 17, wherein the tag mapping includes at least a mapping between the first tag and one of a tunnel or a classless inter domain routing (CIDR) group, the operations further comprising:
receiving, by the vPoP and from the first network element, a data packet associated with the first tag and the at least one of the tunnel or the CIDR group;
based at least in part on the tag mapping, causing the data packet to be associated with the second tag; and
based at least in part on the data packet being associated with the second tag, sending the data packet to the second network element.

19. The one or more non-transitory computer-readable media of claim 17, wherein the tag mapping includes at least a mapping between the first tag and one of a tunnel or a classless inter domain routing (CIDR) group, the operations further comprising:
receiving, by the vPoP and from the first network element, a data packet associated with a third tag and the at least one of the tunnel or the CIDR group; and
based at least in part on the tag mapping, refraining from causing the data packet to be associated with the second tag.

20. The one or more non-transitory computer-readable media of claim 17, the operations further comprising:
identifying a third network element in the MCN, the third network element being associated with the cloud account;
identifying a third tag of the third network element;
determining that the third tag corresponds to the first tag and the second tag; and
updating the tag mapping to include an indication of the third tag.
